(19) United States
(12) Patent Application Publication
(10) Pub. No.: US 2015/0365856 A1
(43) Pub. Date: Dec. 17, 2015

(54) MANAGING RADIO RESOURCE CONTROL (RRC) STATE TRANSITIONS AT A USER EQUIPMENT

(71) Applicant: QUALCOMM Incorporated, San Diego, CA (US)

(72) Inventors: Sathish KRISHNAMOORTHY, Hyderabad (IN); Liangchi HSU, San Diego, CA (US); Ansah Ahmed SHEIK, Hyderabad (IN); Vagish GUPTA, Hyderabad (IN); Adarsh Kumar JINNU, Hyderabad (IN); Srinivas Reddy ANNEM, Hyderabad (IN); Yongsheng SHI, San Diego, CA (US); Mohamed Abdelrazek EL-SAIDNY, Dubai (AE)

(21) Appl. No.: 14/603,192

(22) Filed: Jan. 22, 2015

Related U.S. Application Data
(60) Provisional application No. 62/013,102, filed on Jun. 17, 2014.

(51) Int. Cl. H04W 36/00

(52) U.S. Cl. CPC H04W 36/0072

(57) ABSTRACT

The present disclosure presents a method and an apparatus for managing radio resource control (RRC) state transitions at a user equipment (UE). For example, the method may include transmitting a reconfiguration complete message to a network entity, starting a reselection delay timer simultaneously with the transmitting of the reconfiguration complete message, identifying initiation of a cell reselection procedure at the UE, delaying the cell reselection procedure at the UE until the UE receives a layer 2 acknowledgement (L2 ACK) message from the network entity, stopping the reselection delay timer in response to receiving the L2 ACK message, and transitioning the UE to a cell_paging channel (cell_PCH) state from a cell_forward access channel (cell_FACH) state after the stopping of the reselection delay timer. As such, managing RRC state transitions at a UE may be achieved.

### CLAIM OF PRIORITY

The present application for patent claims priority to U.S. Provisional Patent Application No. 62/013,102, filed Jun. 17, 2014, entitled “Apparatus and Method to Avoid out of Synch when Reconfiguration Procedure Colliding with Cell Update Procedure,” which is assigned to the assignee hereof, and hereby expressly incorporated by reference herein.

### BACKGROUND

Aspects of the present disclosure relate generally to wireless communication systems, and more particularly, to RRC state transitions at a user equipment (UE).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A network entity may trigger RRC state transition of a UE from a cell_forward access channel (cell_FACH) state to a cell_paging channel (cell_PCH) state if the amount of data to transfer on an uplink (UL) is less than a threshold or if there is no data to transfer on the UL. Such RRC state transitions may be frequently triggered due to fast dormancy feature as defined by 3GPP Specifications. Additionally, a UE may initiate a cell reselection when the RRC state transition of the UE from cell_FACH to cell_PCH state is in progress.

For example, when a RRC state transition of a UE from cell_FACH to cell_PCH state is triggered by a reconfiguration message from the network entity, the UE processes the reconfiguration message, and sends a reconfiguration complete message to the network entity. The network entity updates the UE's RRC state at the network entity to cell_PCH state on receiving the reconfiguration complete message. However, the UE has to receive a layer 2 acknowledgement (L2 ACK) message from the network entity to complete the RRC state transition and update the UE's RRC state to cell_PCH at the UE (i.e., the UE remains in cell_PCH state until the L2 ACK messages is received at the UE from the network entity). When the UE is waiting for L2 ACK message from the network entity, a cell reselection may be triggered at the UE (e.g., due to UE mobility). This may result in a mismatch in UE's RRC states at the UE and the network entity. That is, the RRC state (i.e., of the UE) at the UE and the network entity may be out of sync which may affect the performance of the UE and/or the network entity.

Thus, there is a desire for managing RRC state transitions at a user equipment to avoid mismatch scenarios.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for managing radio resource control (RRC) state transitions at a user equipment (UE). For example, the present disclosure presents an example method for transmitting a reconfiguration complete message to a network entity, wherein the reconfiguration complete message is transmitted to the network entity in response to receiving a reconfiguration message from the network entity, starting a reselection delay timer simultaneously with the transmitting of the reconfiguration complete message, identifying initiation of a cell reselection procedure at the UE, delaying the cell reselection procedure at the UE until the UE receives a layer 2 acknowledgement (L2 ACK) message from the network entity, stopping the reselection delay timer in response to receiving the L2 ACK message, and transitioning the UE to a cell_paging channel (cell_PCH) state from a cell_forward access channel (cell_FACH) state after the stopping of the reselection delay timer.

Additionally, the present disclosure presents an example apparatus for managing radio resource control (RRC) state transitions at a user equipment (UE) that may include means for transmitting a reconfiguration complete message to a network entity, wherein the reconfiguration complete message is transmitted to the network entity in response to receiving a reconfiguration message from the network entity, means for starting a reselection delay timer simultaneously with the transmitting of the reconfiguration complete message, means for identifying initiation of a cell reselection procedure at the UE, means for delaying the cell reselection procedure at the UE until the UE receives a layer 2 acknowledgement (L2 ACK) message from the network entity, means for stopping the reselection delay timer in response to receiving the L2 ACK message, and means for transitioning the UE to a cell_paging channel (cell_PCH) state from a cell_forward access channel (cell_FACH) state after the stopping of the reselection delay timer.

In a further aspect, the presents disclosure presents an example non-transitory computer readable medium storing computer executable code for managing radio resource control (RRC) state transitions at a user equipment (UE) that may include code for transmitting a reconfiguration complete message to a network entity, wherein the reconfiguration complete message is transmitted to the network entity in response to receiving a reconfiguration message from the network entity, code for starting a reselection delay timer simultaneously with the transmitting of the reconfiguration complete message, code for identifying initiation of a cell reselection procedure at the UE, code for delaying the cell reselection procedure at the UE until the UE receives a layer 2 acknowledgement (L2 ACK) message from the network entity, code for stopping the reselection delay timer in response to receiving the L2 ACK message, and code for transitioning the UE to a cell_paging channel (cell_PCH) state from a cell_forward access channel (cell_FACH) state after the stopping of the reselection delay timer.

Furthermore, in an aspect, the present disclosure presents an example apparatus for managing radio resource control (RRC) state transitions at a user equipment (UE) that may include a reconfiguration message component to transmit a reconfiguration complete message to a network entity, wherein the reconfiguration complete message is transmitted to the network entity in response to receiving a reconfiguration message from the network entity, a timer starting component to start a reselection delay timer simultaneously with the transmitting of the reconfiguration complete message, a reselection component to identify initiation of a cell reselection procedure at the UE, the reselection component to delay the cell reselection procedure at the UE until the UE receives a layer 2 acknowledgement (L2 ACK) message from the network entity, a time stopping component to stop the reselection delay timer in response to receiving the L2 ACK message, and a state transition component to transition the UE to a cell_paging channel (cell_PCH) state from a cell_forward access channel (cell_FACH) state after the stopping of the reselection delay timer.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a flowchart illustrating an example aspect of a UE and a network entity out of sync;

FIG. 3 is a flowchart illustrating an example aspect of managing RRC state transitions of a UE and a network entity;

FIG. 4 is a flow diagram illustrating aspects of an example method in aspects of the present disclosure;

FIG. 5 is a block diagram illustrating aspects of an example user equipment including a state transition manager according to the present disclosure;

FIG. 6 is a block diagram conceptually illustrating an example of a telecommunications system including a user equipment with a state transition manager according to the present disclosure;

FIG. 7 is a conceptual diagram illustrating an example of an access network including a user equipment with a state transition manager according to the present disclosure;

FIG. 8 is a conceptual diagram illustrating an example of a radio protocol architecture for the user and control plane that may be used by the user equipment of the present disclosure; and

FIG. 9 is a block diagram conceptually illustrating an example of a Node B in communication with a UE, which includes a state transition manager according to the present disclosure, in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides a method and apparatus for managing radio resource control (RRC) state transitions at a user equipment (UE) that may include transmitting a reconfiguration complete message to a network entity, wherein the reconfiguration complete message is transmitted to the network entity in response to receiving a reconfiguration message from the network entity, starting a reselection delay timer simultaneously with the transmitting of the reconfiguration complete message, identifying initiation of a cell reselection procedure at the UE, delaying the cell reselection procedure at the UE until the UE receives a layer 2 acknowledgement (L2 ACK) message from the network entity, stopping the reselection delay timer in response to receiving the L2 ACK message, and transitioning the UE to a cell_paging channel (cell_PCH) state from a cell_forward access channel (cell_FACH) state after the stopping of the reselection delay timer.

Further, the present disclosure provides a method and an apparatus for improving performance at the UE and/or network entity when a circuit switched (CS) mobile terminated (MT) call indication or a packet switched (PS) downlink (DL) data arrives at the UE when RRC state transition is in progress at the UE. Furthermore, the present disclosure provides a method and an apparatus for improving performance at the UE and/or network entity when the UE is camped on a UMTS RAT and IRAT reselection or handover to a LTE occurs when a mobile originated (MO) or MT CS call setup is progress.

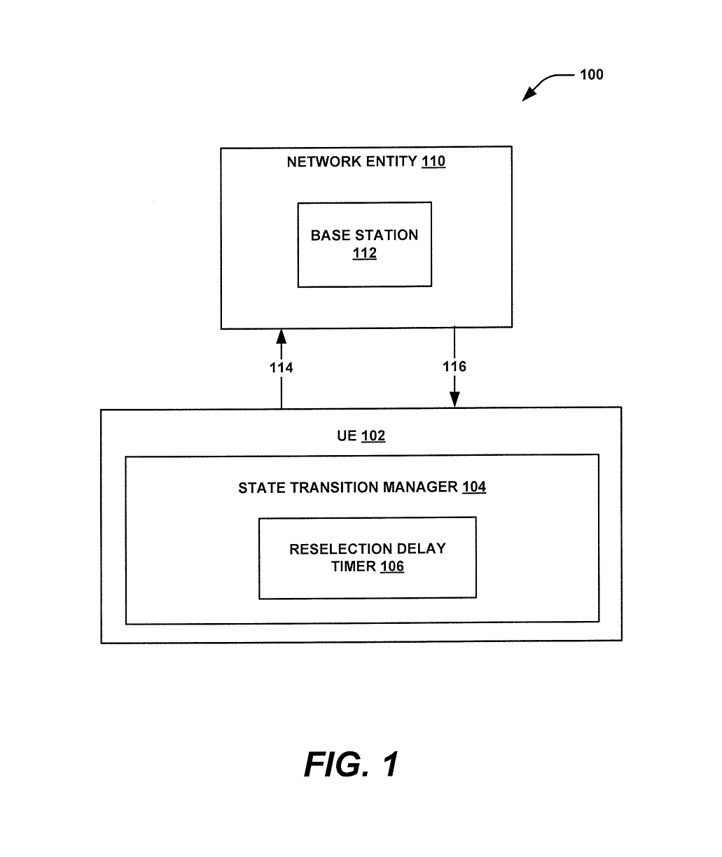

Referring to FIG. 1, a wireless communication system 100 is illustrated that facilitates managing radio resource control (RRC) state transitions at a user equipment (UE). For example, system 100 includes a UE 102 that may communicate with a network entity 110 and/or base station via one or more over-the-air links 114 and/or 116. For example, UE 102 may communicate with base station 112 on an uplink (UL) 114 and/or a downlink (DL) 116. The UL 114 is generally used for communication from UE 102 to base station 112 and/or the DL 116 is generally used for communication from base station 112 to UE 102.

In an aspect, network entity 110 may include one or more of any type of network components, for example, an access point, including a base station (BS) or Node B or eNode B or a femto cell, a relay, a peer-to-peer device, an authentication, authorization and accounting (AAA) server, a mobile switching center (MSC), a radio network controller (RNC), etc., that can enable UE 102 to communicate and/or establish and maintain wireless communication links 114 and/or 116, which may include a communication session over a frequency or a band of frequencies that form a communication channel, to communicate with network entity 110 and/or base station 112. In an additional aspect, for example, base station 112 may operate according to a radio access technology (RAT) standard, e.g., GSM, CDMA, W-CDMA, HSPA or a long term evolution (LTE).

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, UE 102 may be configured to include a state transition manager 104 to manage RRC state transitions at UE 102. For example, in an aspect, state transition manager 104 may start a reselection delay timer 106 upon sending a reconfiguration complete message to network entity 110 and delay a cell reselection procedure at UE 102 until the UE receives a layer 2 acknowledgement (L2 ACK) message (for the reconfiguration complete message) from network entity 110.

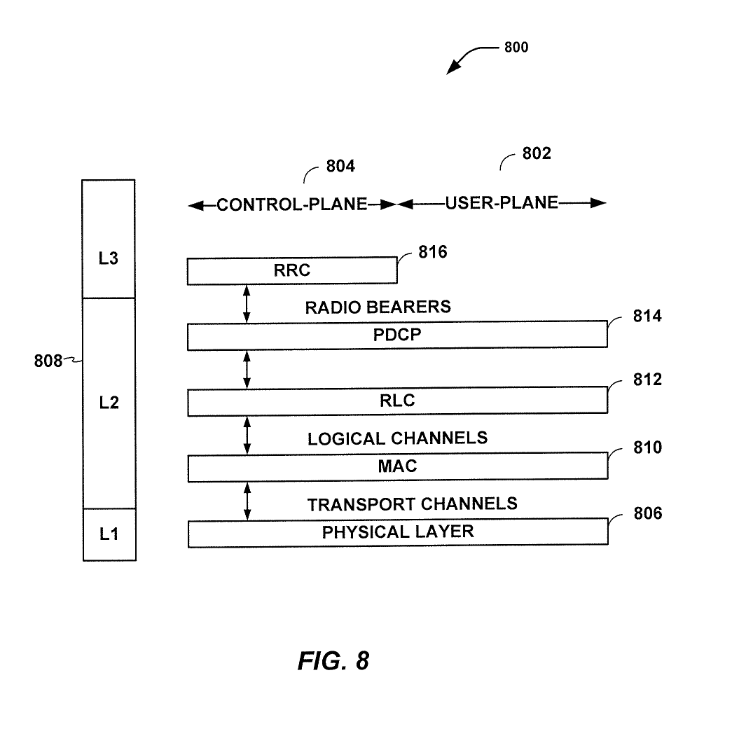

For example, in an aspect, state transition manager 104 may configured UE 102 to transmit a reconfiguration complete message to a network entity in response to receiving a reconfiguration message from the network entity, identify initiation of a cell reselection procedure at the UE, start a reselection delay timer, delay the cell reselection procedure at the UE until the UE receives a layer 2 acknowledgement (L2 ACK) message from the network entity, stop the reselection delay timer in response to receiving the L2 ACK message, and transition the UE to a cell_paging channel (cell_PCH) state from a cell_forward access channel (cell_FACH) state after the stopping of the reselection delay timer. Layer 2 (L2 layer) is above the physical layer and is responsible for the link between UE 102 and Network Entity 110 (e.g., base station 112), described in detail below in reference to FIG. 8.

In an additional or optional aspect, state transition manager 104 may configure UE 102 to continue with the cell reselection procedure after the transitioning of the UE to the cell_PCH state.

Additional aspects, which may be performed in combination with the above aspects or independently thereto, are discussed below and may lead to reducing and/or elimination RRC state out of sync scenarios.

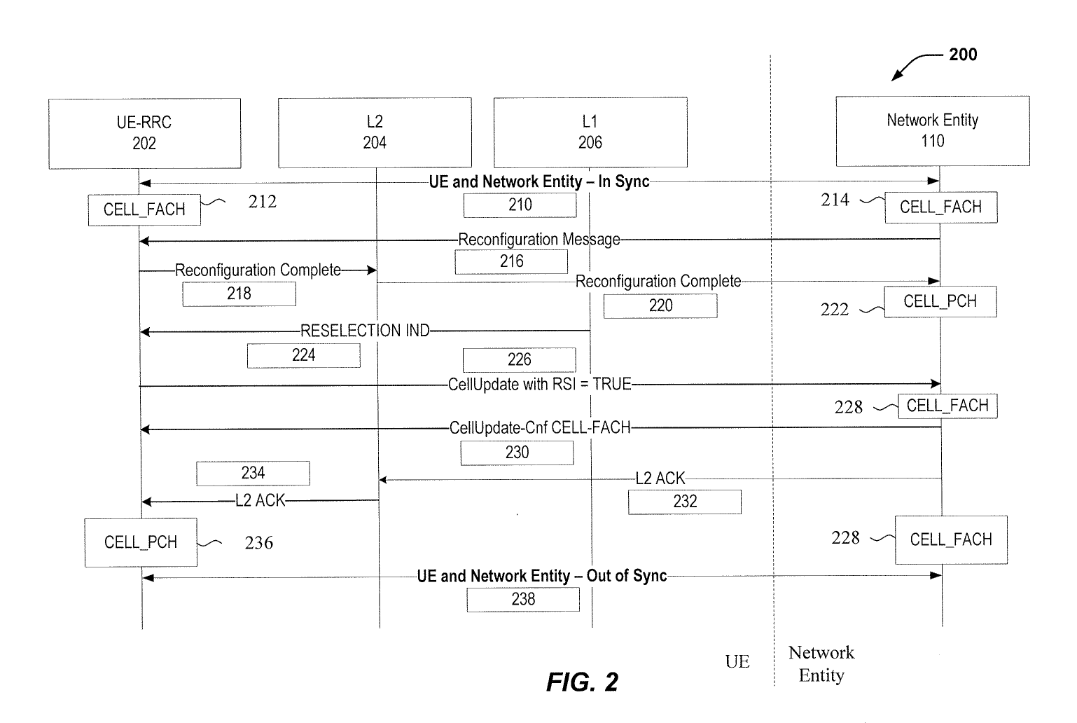

FIG. 2 illustrates an example flowchart 200 with UE's RRC state out of sync at the UE and the network entity when a cell reselection is triggered at the UE while a RRC state transition is in progress at the UE.

For instance, a network entity 110 may update the RRC state of a UE 102 to cell_PCH state (from cell_FACH state) upon receiving a reconfiguration complete message from the UE. However, UE 102 may not update it's RRC state to cell_PCH state until the UE receives a L2 ACK message from network entity 110. During the time, when the UE is waiting for the L2 ACK message from the network entity, a cell reselection may be initiated at the UE (e.g., due to UE mobility). The initiation of cell reselection at the UE may trigger a cell update (CU) message with a reconfiguration status indicator (RSI) set to TRUE. Once the network entity receives the CU message with RSI set to TRUE, the network entity updates its RRC state of the UE to cell_FACH state (i.e., reverts back to cell_FACH state), and sends a CU Confirm message with RRC state set to cell_FACH. That is, network entity confirms the RRC state of UE (e.g., cell_FACH state) and commands or instructs the UE to transition to cell_FACH state. But, as the UE is already in the cell_FACH state, UE may ignore this message. Since the cell reselection initiated earlier at the UE is in progress, the UE may receive the L2 ACK message from the network entity, and the UE may transition its RRC state to cell_PCH state. As the RRC state of the UE at the network entity is in cell_FACH state, the UE and network entity are out of sync regarding the RRC state of the UE. This may affect the performance of the UE and/or network entity (e.g., call origination failures, etc.).

At block 210, the RRC state of the UE at UE 102 and network entity 110 are in sync, e.g., in cell_FACH state. For example, at block 212, UE 102 is in a cell_FACH state, and at block 214, network entity 110 is in sync with the RRC state of the UE in cell_FACH state. At block 216, UE 102 may receive a reconfiguration message 216, e.g., a physical channel reconfiguration message, from network entity to transition radio resource control (RRC) state of UE 102 to cell_PCH state. The reconfiguration message may include a set of RRC parameters instructing the UE to update its configuration information. For example, a physical channel carries the payload data and governs the physical characteristics of a signal. In contrast, a logical channel defines the way in which data will be transferred and a transport channel along with the logical channel again defines the way in which the data is transferred.

The transition of UE 102 to cell_PCH state may be triggered by 3GPP fast dormancy features, and may include releasing a set of physical channels used by UE 102. The receiving of the reconfiguration message from the network entity 110 may be trigged in response to UE 102 sending a signaling connection release indicator (SCRI) message (e.g., triggered by the fast dormancy feature) to network entity 110. However, the UE does not transition its state to cell_PCH and remains in cell_FACH state. At block 218, UE 102 sends a reconfiguration complete message to layer 2 204 (L2) of the UE which is then transmitted to network entity 110 at block 220. At block 222, network entity 110 updates RRC state of UE 102 to cell_PCH state upon receiving the reconfiguration complete message 220 from the UE.

The fast dormancy feature may be enabled at UE 102 and/or network entity 110. The fast dormancy feature may include UE 102 notifying network entity 110 to initiate a radio resource control (RRC) release without tearing the down an existing packet data protocol (PDP) context as it reduces the signaling time to recover a data connection that has been established before. The RRC layer is teared down while keeping the non-access stratum (NAS) layer so that the PDP connection may be recovered much faster when it is needed. For example, when the fast dormancy feature is enabled, network entity 110 may trigger RRC state transitions of a UE from a cell_forward access channel (cell_FACH) state to a cell_paging channel (cell_PCH) state if the amount of data to transfer on an uplink (UL) (e.g., from UE 102 to network entity on UL 114) is less than a threshold (e.g., configured by network entity 110 and/or UE 102) and/or if there is no data to transfer on the UL. Other RRC states may include cell_dedicated channel (cell_DCH) and UTRAN Registration Area Paging channel (URA_PCH).

A cell_FACH state may be characterized, for example, by the following features: no dedicated physical channel is allocated to a UE, the UE continuously monitors a FACH in the downlink, the UE is assigned a default common/shared transport channel in the uplink (e.g., random access channel, RACH) that the UE can use anytime, and the position of the UE is known by the network entity 110 (e.g., UTRAN) on a cell level based on the cell where the UE last made a cell update. A fundamental access channel is a common transport channel available across the cell radius for signaling procedures, e.g., a registration procedure.

A cell_PCH state may be characterized, for example, by the following features: no dedicated physical channel is allocated to a UE, the UE selects a PCH and uses discontinuous reception (DRX) for monitoring the selected PCH via an associated paging indicator channel (PICH), no uplink activity is possible, and the position of UE 102 is known by the network entity 110 (e.g., UTRAN) on a cell level based on the cell where the UE last made a cell update in cell_FACH state. A paging channel (PCH) is a downlink transport channel which is transmitted over an entire cell. The transmission of the PCH is associated with the transmission of physical-layer generated paging indicators to support efficient sleep-mode procedures. The PICH is a fixed rate physical channel used to carry the paging indicators. A dedicated channel (DCH) may include a dedicated control channel (DCCH) which is used to carry dedicated control information in both directions and a dedicated traffic channel (DTCH) which is used to transport user data from a base station to a specific UE and vice versa.

A cell_DCH state may be characterized, for example, by the following features: a dedicated physicall channel is allocated to the UE in uplink and downlink, the UE is known on a cell level according to its current active set. A UTRAN Registration Area_Paging channel (URA_PCH) state may be characterized, for example, by the following features: neither an uplink nor a downlink dedicated physicall channel is allocated to the UE, the UE uses discontinuous receiving (DRX) for monitoring a PCH via an allocated PICH, no uplink activity is possible, and the UE is known on URRA level according to the URA assigned to the UE during the last URA update in the cell_FACH state.

At block 224, UE 102 may initiate a cell reselection (e.g., at layer 1 (L1) 206 of the UE). The cell reselection may have been initiated, for example, due to UE mobility, as per cell reselection criteria defined in the 3GPP Specifications. At block 226, UE 102 may send a cell update (CU) message with reconfiguration status indicator (RSI) set to TRUE to indicate that a reconfiguration is in progress at the UE and/or the UE is waiting for a L2 ACK from the network entity. At block 228, network entity 110 updates (or reverts) the RRC state of UE 102 to cell_FACH state upon receiving the cell update message with RSI set to TRUE.

At block 230, network entity 110 sends a cell update confirm message with a RRC state of cell_FACH state to the UE in response to receiving the reconfiguration complete message at block at 220. That is, network entity confirms the RRC state of UE (e.g., cell_FACH state) and commands or instructs the UE to transition to cell_FACH state. But, as the UE is already in the cell_FACH state, UE may ignore this message. At block 234, UE 102 receives L2 ACK message from the network entity (e.g., L2 acknowledgement for the reconfiguration message sent by UE at block 218) and transitions the RRC state of the UE to cell_PCH state at block 236. The L2 ACK message may a RLC acknowledgement, e.g., a control PDU from the network entity indicating that the last piece (e.g., last bits) of the RRC message has been received by the network entity. However, this results in a mis-match of the UE's RRC state as the RRC state of UE is in cell_PCH at the UE (e.g., block 236) and in cell_FACH state at the network entity (e.g., block 228).

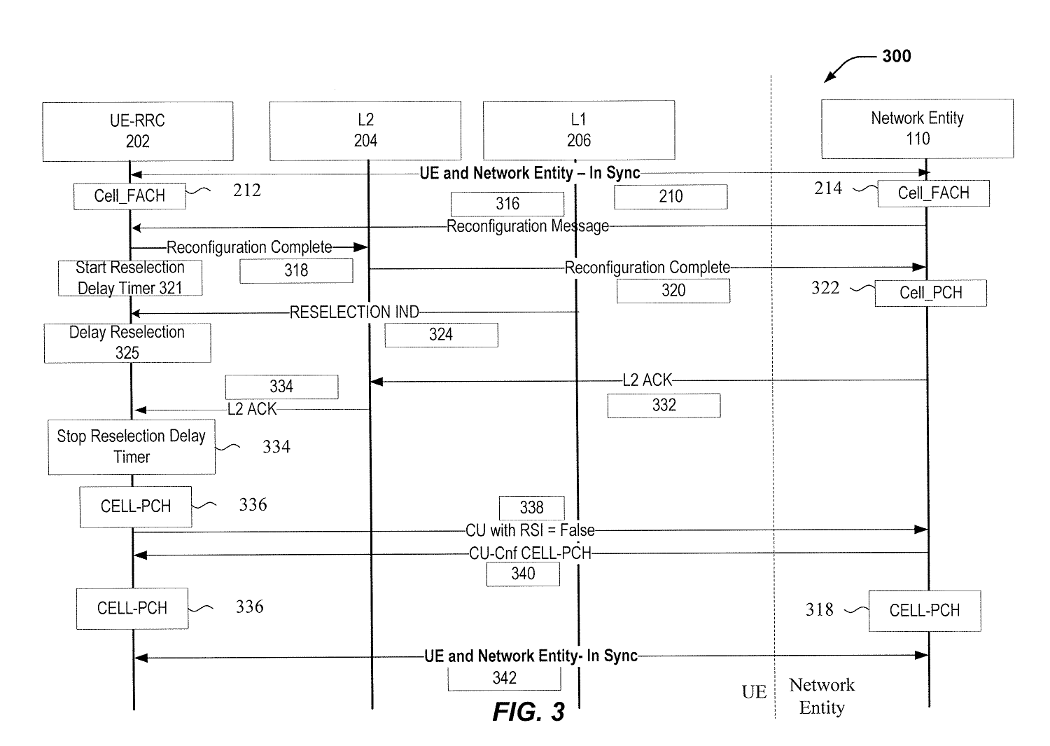

FIG. 3 illustrates an example aspect of a flowchart 300 for managing RRC state transitions at UE 102 when a cell reselection is triggered at the UE while a RRC state transition is in progress at the UE.

For instance, in an aspect, network entity 110 may update the RRC state of UE 102 to cell_PCH state (from cell_FACH state) upon receiving a reconfiguration complete message from the UE. However, UE 102 may not update it's RRC state to cell_PCH state until the UE receives a L2 ACK message from network entity 110. Therefore, the UE may start a reselection delay timer to delay (or defer) any cell reselection that may be initiated at the UE when the UE is waiting for the L2 ACK message from the network entity and/or until the reselection delay timer expires. This stops (or reduces the occurrences, prevents, etc.) the UE and network entity from getting out of sync with each other regarding the UE's RRC state, as described in detail below.

During the time, when the UE is waiting for the L2 ACK message from the network entity, a cell reselection may be initiated at the UE (e.g., due to UE mobility) and ma. The initiation of cell reselection at the UE may trigger a cell update (CU) message with a reconfiguration status indicator (RSI) set to TRUE. Once the network entity receives the CU message with RSI set to TRUE, the network entity updates its RRC state of the UE to cell_FACH state (i.e., reverts back to cell_FACH state), and sends a CU Confirm message with RRC state set to cell_FACH. That is, network entity confirms the RRC state of UE (e.g., cell_FACH state) and commands or instructs the UE to transition to cell_FACH state. But, as the UE is already in the cell_FACH state, UE may ignore this message. Since the cell reselection initiated earlier at the UE is in progress, the UE may receive the L2 ACK message from the network entity, and the UE may transition its RRC state to cell_PCH state. As the RRC state of the UE at the network entity is in cell_FACH state, the UE and network entity are out of sync regarding the RRC state of the UE. This may affect the performance of the UE and/or network entity (e.g., call origination failures, etc.).

At block 210, the RRC state of the UE at UE 102 and network entity 110 are in sync, e.g., in cell_FACH state. For example, at block 212, UE 102 is in a cell_FACH state, and at block 214, network entity 110 is in sync with the RRC state of the UE in cell_FACH state.

At block 316, UE 102 may receive a reconfiguration message, e.g., a physical channel reconfiguration message from network entity 110 to transition RRC state of UE 102 to cell_PCH state (from cell_FACH at block 212).

At block 318, UE 102 sends a reconfiguration complete message to layer 2 204 (L2), after processing the reconfiguration message received from the network entity, which is then transmitted to network entity 110 at block 320. The UE then waits for a L2 ACK message from the network entity before updating its RRC state to cell_PCH. However, at block 322, network entity 110 updates the RRC state of UE 102 to cell_PCH.

At block 321, UE 102 and/or state transition manager 104 starts a reselection delay timer 321. The reselection delay timer 321 may be started simultaneously with the sending of the reconfiguration complete message at block 318. The reselection delay timer 321 delays any cell reselections initiated at UE 102 if/when a cell reselection is triggered at UE 102 when the reconfiguration procedure is in progress at UE. That is, any cell reselections initiated at UE 102 are delayed until the timer expires and/or until the UE receives an L2 ACK message from the network entity. As the UE waits for the L2 ACK message from the network entity 110, the reconfiguration procedure is not complete, and the UE has not updated its RRC status to cell_PCH (i.e., UE's RRC state is still cell_FACH).

At block 324, a cell reselection may be initiated at UE 102. For example, the cell reselection may be initiated at UE 102 due to UE's mobility or for other reasons (e.g., signal strength issues, etc.) as per cell reselection criteria. Once cell reselection is triggered at UE 102 and the reselection delay timer is running, at block 325, state transition manager 104 may delay cell reselection procedure at UE 102 until the UE receives the L2 ACK message and/or the timer expires. In an aspect, the cell reselection may be delayed when the quality of the current serving cell is still good (e.g., does not affect the performance of the UE and/or the network). For example, in an aspect, the cell reselection may be delayed when the quality of the current serving cell is above a threshold value (e.g., serving cell criteria, signal threshold value) to avoid the session being dropped. In an additional or optional aspect, state transition manager 104 may configure reselection delay timer to 500 ms which may be long enough for UE 102 to receive the L2 ACK message from the network entity so that the UE could transition to cell_PCH state (and resuming of the cell reselection that has been delayed).

At block 332, L1 206 of UE 102 may receive the L2 ACK message from network entity 110 and at block 334, UE 102 may receive the L2 ACK message from the L2 204 of the UE. At block 334, once the UE receives the L2 ACK message, state transition manager 104 may stop reselection delay timer and at block 336 update/transition the RRC state of UE 102 to cell_PCH state.

At block 338, UE 102 may send a configuration update (CU) message 338 to network entity with reconfiguration status indicator (RSI) set to false. In an aspect, a cell update message from the UE with RSI set to false in an CU message indicates that no reconfiguration procedures are in progress at the UE. At block 340, network entity 110 sends a cell update confirm message with a RRC state of cell_PCH state to the UE in response to receiving the CU message. In an additional or optional aspect, UE 102 and/or state transition manager 104 may be configured to address a scenario where network entity 110 may ignore a reconfiguration failure message after cell update procedure.

Thus, the RRC state of a UE may be managed to minimize, reduce, avoid, and/or eliminate any mis-match scenarios.

In an additional or optional aspect, the 3GPP cell update (CU) procedure may be modified to include new indicators in cell update and cell update confirm messages to clearly indicate (e.g., exchange, inform, etc.) the status of reconfiguration procedure between the UE and network entity. The new indicators, if supported by the UE and the network entity, may ensure that a previous reconfiguration procedure is completed to address any ambiguities in RRC state (e.g., RRC target state) or configuration status used by the UE and/or network entity due to cell update procedures. Additionally, as the RRC target state indicated in a cell update confirm message is deterministic and final, no further delay may be involved in starting any pending procedures such as MT/MO call, DL PS data, which might have arrived from the core network during state transition of UE to cell_PCH state.

For instance, in an aspect, the following indicators (e.g., one or more in any combination) may be used to manage state transitions at the UE via a cell update (CU) message (from the UE to the network entity) and/or cell update confirm (CUC) message (from the network entity to the UE). A new CU indicator may be used to indicate whether the RRC target state in the previous reconfiguration is granted by the UE, e.g., value=TRUE/FALSE or Absent. A new CUC indicator may be used to indicate whether the network entity accepted the new CU indicator, e.g., value=Accepted or Absent. An example of usages/combinations of these two indicators is described below.

CU indicator value=TRUE and CUC indicator value=Accepted: This means that the previous CU procedure successfully completed, variable ordered_reconfig is reset, CUC state is Final, and a reconfiguration complete message will follow corresponding to previously completed CU procedure.

CU indicator value=FALSE and CUC indicator value=Accepted, this means that the previous procedure failed, variable ordered_reconfig is reset, CUC state is Final, and a reconfiguration failure message will follow corresponding to previously failed procedure.

CU indicator value=TRUE/FALSE and CUC indicator value=Absent, network entity does not support new indicators and previous reconfiguration procedure continues after CUC.

CU indicator value=Absent and CUC indicator value=absent, UE does not support new indicators, so previous reconfig procedure continues after CUC.

In an aspect, the two new indicators, the first one in a CU message and the second one in a CUC message, are applicable only when the RRC target state is cell_PCH. For other RRC target states, the new indicators are not applicable, while the existing RSI indicator in CU message is applicable. In other words, with Solution 2, the RSI is not applicable for reconfiguration procedure that has a RRC target state of cell_PCH state.

Note the procedure described above provides a solution to the issue however this requires 3GPP spec change. Solution 1 only reduces the chances of problem occurrence. However this does not require any 3GPP specification change.

Further, the present disclosure provides a method and an apparatus for improving performance at the UE and/or network entity when a circuit switched (CS) mobile terminated (MT) call indication or a packet switched (PS) downlink (DL) data arrives at the UE when RRC state transition is in progress at the UE.

In an addition aspect, when a mobile originated/mobile terminated (MO/MT) circuit switched (CS) voice call setup is in progress at UE 102, and network entity 110 initiates inter-radio access technology (IRAT) reselection (e.g., 3G to 4G, UMTS to LTE), the MO/MT CS call setup at the UE may be affected. This is due to lack of support for CS voice calls (e.g., MT/MO CS voice calls) in 4G/LTE networks. Additionally, the UE may initiate a circuit switched fallback (CSFB) after reselection to LTE to continue the CS call up based on silent redial feature. CSFB allows handling of voice traffic by circuit-switched (CS) networks (e.g., 2G/3G networks) while data traffic is generally handled by 3G/4G packet-switched (PS) networks. However, the CS call setup may fail or take longer to finish the call setup.

In an aspect, UE 102 may abort IRAT reselection measurements when the UE is in cell_FACH, cell_PCH, or idle state and a MT/MO CS voice call setup is in progress at the UE. In an additional or optional aspect, UE 102 may continue with IRAT reselection measurements and reduce reselection priority of LTE RAT such that the reselection priority of LTE RAT is lower than any other RAT which supports CS voice calls. Additionally, intra-system reselection and measurements (e.g., 3G intra or inter frequency) may still apply as per the current standards based implementation, and the UE may continue MT/MO CS voice call set up without being interrupted for performing IRAT reselection measurements (e.g., for reselection to LTE).

In an additional or optional aspect, if the current serving cell (e.g., 3G serving cell) of the UE 102 becomes unsuitable as a serving cell (e.g., quality of the serving cell deteriorates) during the MO/MT CS call setup, the UE may still search and perform a 3G intra or inter frequency reselection to avoid any degradation to call set up performance. If the MO/MT CS call setup fails (e.g., weak 3G coverage, normal call clearing, missed call at the called party, etc.), and the UE stays in the same RRC state, then the IRAT reselection measurements may be initiated again, and reselection procedure may proceed from its previous state (e.g., if the same LTE cell is measured again) or a new LTE primary or secondary synchronization signal (PSS/SSS) search may be initiated.

Furthermore, the present disclosure provides a method and an apparatus for improving performance at the UE and/or network entity when the UE is camped on a first RAT (e.g., UMTS) and Inter-RAT (IRAT) reselection or handover to a second RAT (e.g., LTE) occurs when a mobile originated (MO) or MT CS call setup is progress.

In an addition aspect, when a mobile originated/mobile terminated (MO/MT) circuit switched (CS) voice call setup is in progress at UE 102, and network entity 110 initiates inter-radio access technology (IRAT) handover (e.g., 3G to 4G, UMTS to LTE handover) with the UE in a cell_DCH state, the MO/MT CS call setup at the UE may be affected. This is due to lack of support for CS voice calls (e.g., MO/MT CS voice calls) in 4G/LTE networks. Additionally, the UE may initiate a circuit switched fallback (CSFB) after handover to LTE to continue the CS call up based on silent redial feature. CSFB allows handling of voice traffic by circuit-switched (CS) networks (e.g., 2G/3G networks) while data traffic is generally handled by 3G/4G packet-switched (PS) networks. However, the CS call setup may fail or take longer to finish the call setup.

In an aspect, UE 102 may abort IRAT handover measurements (to avoid interruption due to IRAT handover) when the UE is in cell_DCH state and a MO/MT CS voice call setup is in progress at the UE. In an additional or optional aspect, if the CS call setup fails for any reason (e.g., weak 3G coverage, etc.), and UE stays in the same RRC state (i.e., cell_DCH state), then the IRAT handover measurements may be re-initiated, and the handover procedure may continue from where it was left before (e.g., when the same LTE cell is measured again), or a new LTE primary/secondary synchronization signal (PSS/SSS) search may be initiated.

In an aspect, where a CS call is initiated and a parallel re-direction from 3G to LTE has reached the UE, the UE may ignore the re-direction to LTE part of the RRC Connection Release or reject the handover command and UE may continue with CS call establishment. There are two possibilities for 3G to LTE handover that can be received simultaneously while UE already started CS call initiation.

For instance, in an aspect, UE 102 may receive a RRC connection release with re-direction info to LTE (e.g., eutra-TargetFreqInfoList), and if the UE CS domain is active due to the CS call setup in progress, the UE may acknowledge the reception of the RRC release but does not act on it. As a result, the UE may send RRC Connection Release Complete but does not act on the redirection info in the RRC Release sent by RNC. The UE would then resume normal operation where the CS call establishment continues or re-attempted, depending on the stage of the CS call establishment. The RNC would understand implicitly that UE has not acted on the redirection info in the RRC Release message due to the ongoing CS call establishment and the RNC therefore does not repeat the release message again nor drop the RRC connection for this UE in this call.

For instance, in an additional aspect, UE receives “HANDOVER FROM UTRAN COMMAND” message with E-UTRA as a target RAT, and if the UE CS domain is active due to the CS call setup, the UE may send a RRC failure message (e.g., an explicit rejection to the handover command) with a proper cause specified in 3GPP and may then resume normal operation as if the invalid HANDOVER FROM UTRAN COMMAND message has not been received. Meanwhile, the RNC can understand implicitly that UE rejected the handover message due to UE's RRC sending handover failure message during the ongoing CS call establishment. The RNC therefore prevents the handover from UTRAN to E-UTRAN in this call, and does not drop the RRC connection for this UE.

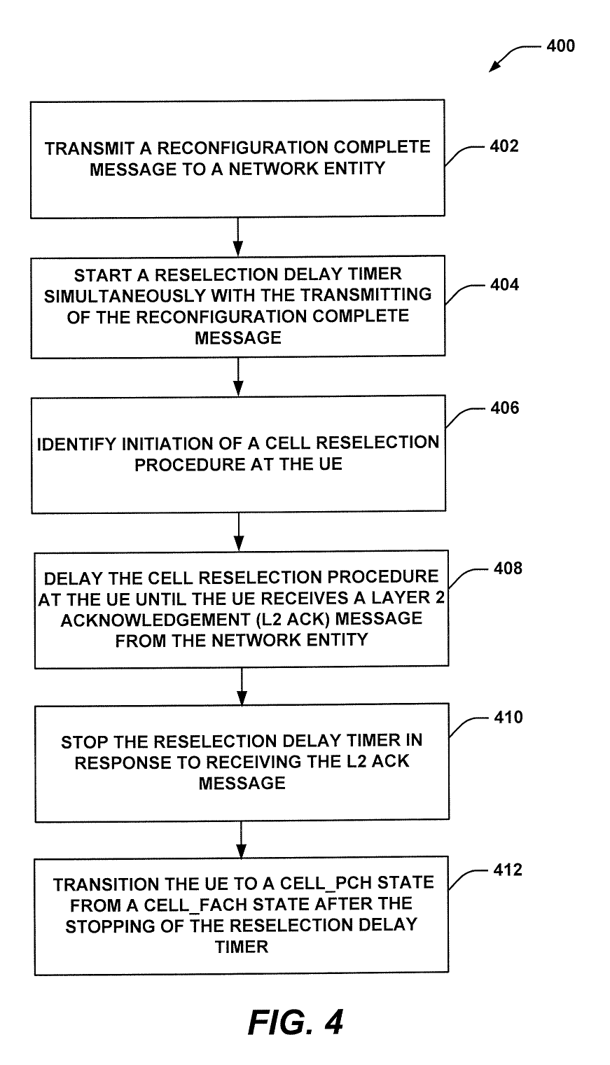

FIG. 4 illustrates an example methodology 400 for managing RRC state transitions at a user equipment (UE).

In an aspect, at block 402, methodology 400 may include transmitting a reconfiguration complete message to a network entity. For example, in an aspect, UE 102 and/or state transition manager 104 may include a specially programmed processor module, or a processor executing specially programmed code stored in a memory, to transmit a reconfiguration complete message to a network entity 110. For instance, in an aspect, UE 102 and/or state transition manager 104 may transmit the reconfiguration complete message to network entity 110 and/or base station 112, such as via a communication component (e.g., a transceiver) of UE 102 transmitting the reconfiguration message via a communication link (e.g., UL 114). In an additional aspect, the reconfiguration complete message is transmitted to network entity 110 (e.g., from UE 102) in response to receiving a reconfiguration message from the network entity 110. In an aspect, state transition manager 104 may include a reconfiguration message component 452 to perform this functionality.

In an aspect, at block 404, methodology 400 may include starting a reselection delay timer simultaneously with the transmitting of the reconfiguration complete message. For example, in an aspect, UE 102 and/or state transition manager 104 may include a specially programmed processor module, or a processor executing specially programmed code stored in a memory, to start a reselection delay timer simultaneously with the transmitting of the reconfiguration complete message. In an aspect, state transition manager 104 may include a timer starting component 454 to perform this functionality.

In an aspect, at block 406, methodology 400 may include identifying initiation of a cell reselection procedure at the UE. For example, in an aspect, UE 102 and/or state transition manager 104 may include a specially programmed processor module, or a processor executing specially programmed code stored in a memory, to identify initiation of a cell reselection procedure at UE 110. For instance, in an aspect, UE 102 and/or state transition manager 104 may identify initiation (or triggering) of a cell reselection procedure based on cell reselection criteria. In an aspect, state transition manager 104 may include a reselection component 456 to perform this functionality.

In an aspect, at block 408, methodology 400 may include delaying the cell reselection procedure at the UE until the UE receives a layer 2 acknowledgement (L2 ACK) message from the network entity. For example, in an aspect, UE 102 and/or state transition manager 104 may include a specially programmed processor module, or a processor executing specially programmed code stored in a memory, to delay the cell reselection procedure at UE 102 until the UE receives a layer 2 acknowledgement (L2 ACK) message from network entity 110. As described above in reference to FIG. 2, delaying the cell reselection at UE 102 gives the UE additional time needed to receive the L2 ACK message so that the UE can transition to cell_PCH state prior to proceeding with the cell reselection to avoid/reduce RRC state mis-match scenarios. In an aspect, state transition manager 104 may include a timer starting component 456 and/or reselection component 456 to perform this functionality.

In an aspect, at block 410, methodology 400 may include stopping the reselection delay timer in response to receiving the L2 ACK message. For example, in an aspect, UE 102 and/or state transition manager 104 may include a specially programmed processor module, or a processor executing specially programmed code stored in a memory, to stop the reselection delay timer in response to receiving the L2 ACK message. In an aspect, state transition manager 104 may include a timer stopping message component 458 to perform this functionality.

In an aspect, at block 412, methodology 400 may include transitioning the UE to a cell_paging channel (cell_PCH) state from a cell_forward access channel (cell_FACH) state after the stopping of the reselection delay timer. For example, in an aspect, UE 102 and/or state transition manager 104 may include a specially programmed processor module, or a processor executing specially programmed code stored in a memory, to transition the UE to a cell_paging channel (cell_PCH) state from a cell_forward access channel (cell_FACH) state after the stopping of the reselection delay timer. In an aspect, state transition manager 104 may include a state transition component 460 to perform this functionality.

In an additional or optional aspect, at block 414, methodology 400 may optionally include continuing with the cell reselection procedure after the transitioning of the UE to the cell_PCH state. For example, in an aspect, UE 102 and/or state transition manager 104 may include a specially programmed processor module, or a processor executing specially programmed code stored in a memory, to continue with the cell reselection procedure after the transitioning of the UE to the cell_PCH state. In an aspect, state transition manager 104 may include reselection component 456 to perform this functionality.

Thus, as described above, RRC state transitions at a UE may be managed.

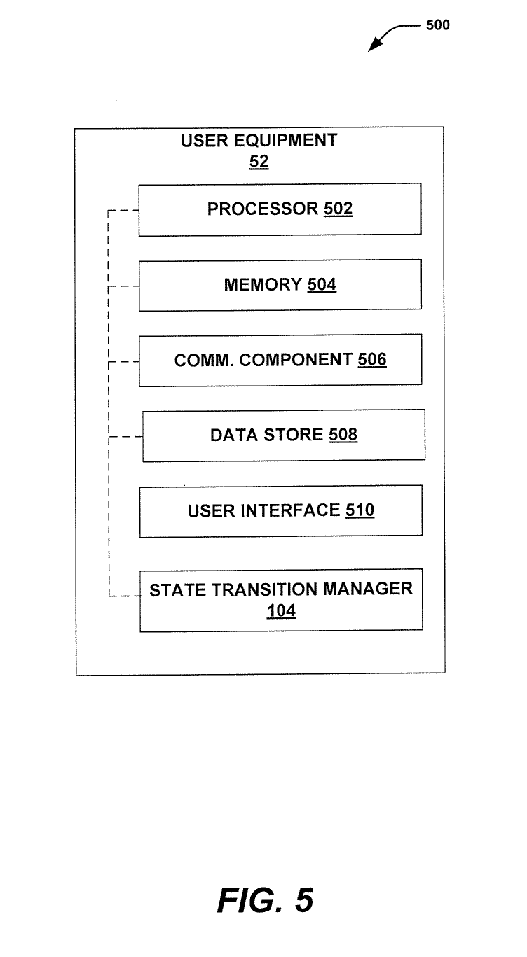

Referring to FIG. 5, in an aspect, UE 102, for example, including state transition manager 104, may be or may include a specially programmed or configured computer device to perform the functions described herein. In one aspect of implementation, UE 102 may include state transition manager 104 and its sub-components, including reconfiguration message component 452, timer starting component 454, reselection component 456, timer stopping component 458, and/or state transition component 460, such as in specially programmed computer readable instructions or code, firmware, hardware, or some combination thereof.

In an aspect, for example as represented by the dashed lines, state transition manager 104 may be implemented in or executed using one or any combination of processor 502, memory 504, communications component 506, and data store 508. For example, state transition manager 104 may be defined or otherwise programmed as one or more processor modules of processor 502. Further, for example, state transition manager 104 may be defined as a computer-readable medium (e.g., a non-transitory computer-readable medium) stored in memory 504 and/or data store 508 and executed by processor 502. Moreover, for example, inputs and outputs relating to operations of state transition manager 104 may be provided or supported by communications component 506, which may provide a bus between the components of computer device 500 or an interface for communication with external devices or components.

UE 102 may include processor 502 specially configured to carry out processing functions associated with one or more of components and functions described herein. Processor 502 can include a single or multiple set of processors or multi-core processors. Moreover, processor 502 can be implemented as an integrated processing system and/or a distributed processing system.

User equipment 102 further includes memory 504, such as for storing data used herein and/or local versions of applications and/or instructions or code being executed by processor 502, such as to perform the respective functions of the respective entities described herein. Memory 504 can include any type of memory usable by a computer, such as random access memory (RAM), read only memory (ROM), tapes, magnetic discs, optical discs, volatile memory, non-volatile memory, and any combination thereof.

Further, user equipment 102 includes communications component 506 that provides for establishing and maintaining communications with one or more parties utilizing hardware, software, and services as described herein. Communications component 506 may carry communications between components on user equipment 102, as well as between user and external devices, such as devices located across a communications network and/or devices serially or locally connected to user equipment 102. For example, communications component 506 may include one or more buses, and may further include transmit chain components and receive chain components associated with a transmitter and receiver, respectively, or a transceiver, operable for interfacing with external devices.

Additionally, user equipment 102 may further include data store 508, which can be any suitable combination of hardware and/or software, that provides for mass storage of information, databases, and programs employed in connection with aspects described herein. For example, data store 508 may be a data repository for applications not currently being executed by processor 502.

User equipment 102 may additionally include a user interface component 55 operable to receive inputs from a user of user equipment 102, and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

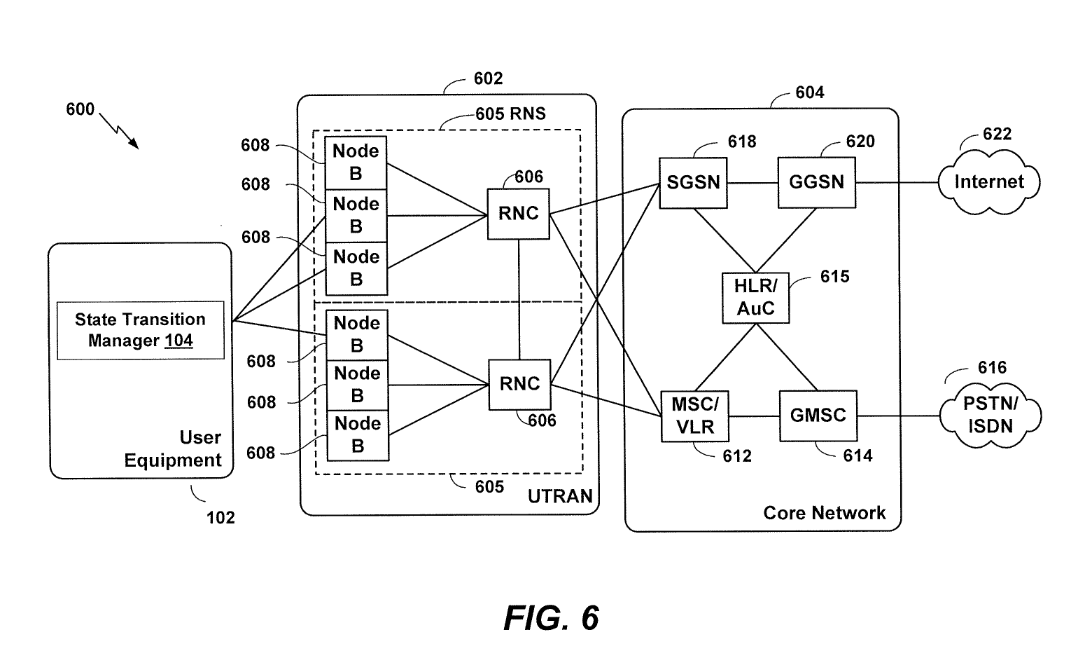

Referring to FIG. 6, by way of example and without limitation, the aspects of the present disclosure are presented with reference to a UMTS system 600 employing a W-CDMA air interface, and may include a UE 102 executing an aspect of state transition manager 104 of FIG. 1. A UMTS network includes three interacting domains: a Core Network (CN) 604, a UMTS Terrestrial Radio Access Network (UTRAN) 602, and UE 102. In an aspect, as noted, UE 102 (FIG. 1) may be configured to perform functions thereof, for example, including managing state transitions at the UE. Further, UTRAN 602 may comprise network entity 110 and/or base station 112 (FIG. 1), which in this case may be respective ones of the Node Bs 608. In this example, UTRAN 602 provides various wireless services including telephony, video, data, messaging, broadcasts, and/or other services. The UTRAN 602 may include a plurality of Radio Network Subsystems (RNSs) such as a RNS 605, each controlled by a respective Radio Network Controller (RNC) such as an RNC 606. Here, the UTRAN 602 may include any number of RNCs 606 and RNSs 605 in addition to the RNCs 606 and RNSs 605 illustrated herein. The RNC 606 is an apparatus responsible for, among other things, assigning, reconfiguring, and releasing radio resources within the RNS 605. The RNC 606 may be interconnected to other RNCs (not shown) in the UTRAN 602 through various types of interfaces such as a direct physical connection, a virtual network, or the like, using any suitable transport network.

Communication between UE 102 and Node B 608 may be considered as including a physical (PHY) layer and a medium access control (MAC) layer. Further, communication between UE 102 and RNC 606 by way of a respective Node B 608 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 66.331 v6.1.0, incorporated herein by reference.

The geographic region covered by the RNS 605 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 608 are shown in each RNS 605; however, the RNSs 605 may include any number of wireless Node Bs. The Node Bs 608 provide wireless access points to a CN 604 for any number of mobile apparatuses, such as UE 102, and may be network entity 110 and/or base station 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 608. The DL, also called the forward link, refers to the communication link from a Node B 608 to a UE 102 (e.g., link 116), and the UL, also called the reverse link, refers to the communication link from a UE 102 to a Node B 608 (e.g., link 114).

The CN 604 interfaces with one or more access networks, such as the UTRAN 602. As shown, the CN 604 is a GSM core network. However, as those skilled in the art will recognize, the various concepts presented throughout this disclosure may be implemented in a RAN, or other suitable access network, to provide UEs with access to types of CNs other than GSM networks.

The CN 604 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 604 supports circuit-switched services with a MSC 612 and a GMSC 614. In some applications, the GMSC 614 may be referred to as a media gateway (MGW). One or more RNCs, such as the RNC 606, may be connected to the MSC 612. The MSC 612 is an apparatus that controls call setup, call routing, and UE mobility functions. The MSC 612 also includes a VLR that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) 615 containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR 615 to determine the UE's location and forwards the call to the particular MSC serving that location.

The CN 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard circuit-switched data services. The GGSN 620 provides a connection for the UTRAN 602 to a packet-based network 622. The packet-based network 622 may be the Internet, a private data network, or some other suitable packet-based network. The primary function of the GGSN 620 is to provide the UEs 104 with packet-based network connectivity. Data packets may be transferred between the GGSN 620 and the UEs 102 through the SGSN 618, which performs primarily the same functions in the packet-based domain as the MSC 612 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 608 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 608 over the HS-DPCCH to indicate whether it correctly decoded a packet on the downlink.

HS-DPCCH further includes feedback signaling from the UE 102 to assist the Node B 608 in taking the right decision in terms of modulation and coding scheme and precoding weight selection, this feedback signaling including the CQI and PCI.

HSPA Evolved or HSPA+ is an evolution of the HSPA standard that includes MIMO and 64-QAM, enabling increased throughput and higher performance. That is, in an aspect of the disclosure, the Node B 608 and/or the UE 102 may have multiple antennas supporting MIMO technology. The use of MIMO technology enables the Node B 608 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 608 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

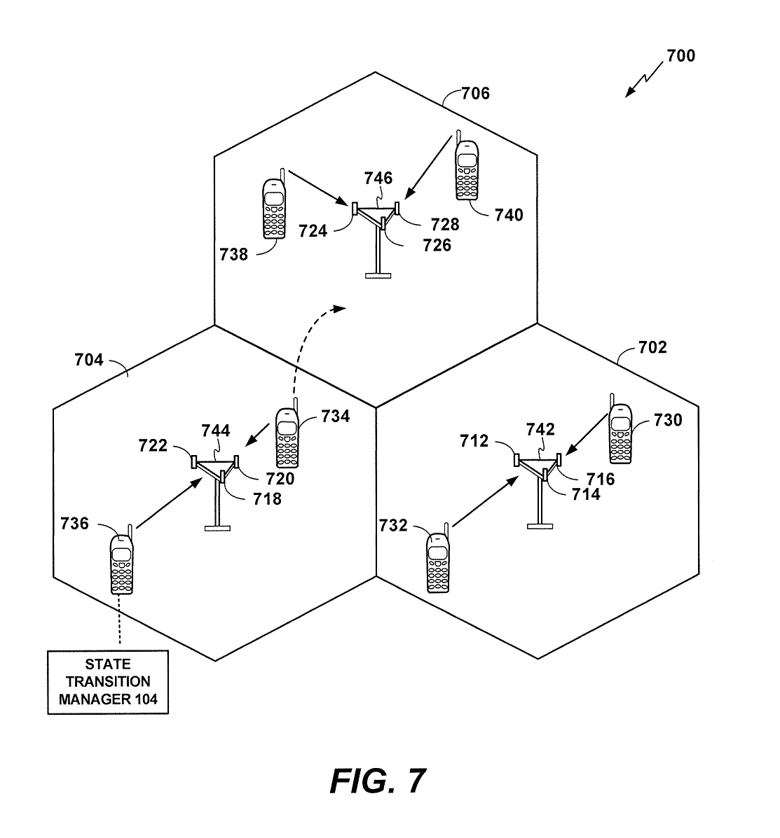

Referring to FIG. 7, an access network 700 in a UTRAN architecture is illustrated, and may include one or more UEs 730, 732, 734, 736, 738, and 740, which may be the same as or similar to UE 102 (FIG. 1) in that they are configured to include state transition manager 104 (FIG. 1; for example, illustrated here as being associated with UE 736) for managing state transitions at the UE. The multiple access wireless communication system includes multiple cellular regions (cells), including cells 702, 704, and 706, each of which may include one or more sectors. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 718, 720, and 722 each correspond to a different sector. In cell 706, antenna groups 724, 726, and 728 each correspond to a different sector. UEs, for example, 730, 732, etc. may include several wireless communication devices, e.g., User Equipment or UEs, including state transition manager 104 of FIG. 1, which may be in communication with one or more sectors of each cell 702, 704 or 706. For example, UEs 730 and 732 may be in communication with Node B 742, UEs 734 and 736 may be in communication with Node B 744, and UEs 738 and 740 can be in communication with Node B 746. Here, each Node B 742, 744, 746 is configured to provide an access point to a CN 604 (FIG. 6) for all the UEs 730, 732, 734, 736, 738, 740 in the respective cells 702, 704, and 706. Additionally, each Node B 742, 744, 746 may be base station 112 and/or and UEs 730, 732, 734, 736, 738, 740 may be UE 102 of FIG. 1 and may perform the methods outlined herein.

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at a radio network controller 606 (FIG. 6), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set). In any case, UE 734 may perform the reselection operations described herein.

Further, the modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented with reference to FIG. 8. FIG. 8 is a conceptual diagram illustrating an example of the radio protocol architecture for the user plane 802 and control plane 804.

Turning to FIG. 8, the radio protocol architecture for the UE, for example, UE 102 of FIG. 1 configured to include state transition manager 104 (FIG. 1) for managing state transitions at a user equipment (e.g., UE 102) is shown with three layers: Layer 1 (L1), Layer 2 (L2), and Layer 3 (L3). Layer 1 is the lowest layer and implements various physical layer signal processing functions. Layer 1 (L1 layer) is referred to herein as the physical layer 806. Layer 2 (L2 layer) 808 is above the physical layer 806 and is responsible for the link between the UE and Node B over the physical layer 806.

In the user plane, L2 layer 808 includes a media access control (MAC) sublayer 810, a radio link control (RLC) sublayer 812, and a packet data convergence protocol (PDCP) 814 sublayer, which are terminated at the Node B on the network side. Although not shown, the UE may have several upper layers above L2 layer 808 including a network layer (e.g., IP layer) that is terminated at a PDN gateway on the network side, and an application layer that is terminated at the other end of the connection (e.g., far end UE, server, etc.).

The PDCP sublayer 814 provides multiplexing between different radio bearers and logical channels. The PDCP sublayer 814 also provides header compression for upper layer data packets to reduce radio transmission overhead, security by ciphering the data packets, and handover support for UEs between Node Bs. The RLC sublayer 812 provides segmentation and reassembly of upper layer data packets, retransmission of lost data packets, and reordering of data packets to compensate for out-of-order reception due to hybrid automatic repeat request (HARQ). The MAC sublayer 810 provides multiplexing between logical and transport channels. The MAC sublayer 810 is also responsible for allocating the various radio resources (e.g., resource blocks) in one cell among the UEs. The MAC sublayer 810 is also responsible for HARQ operations.

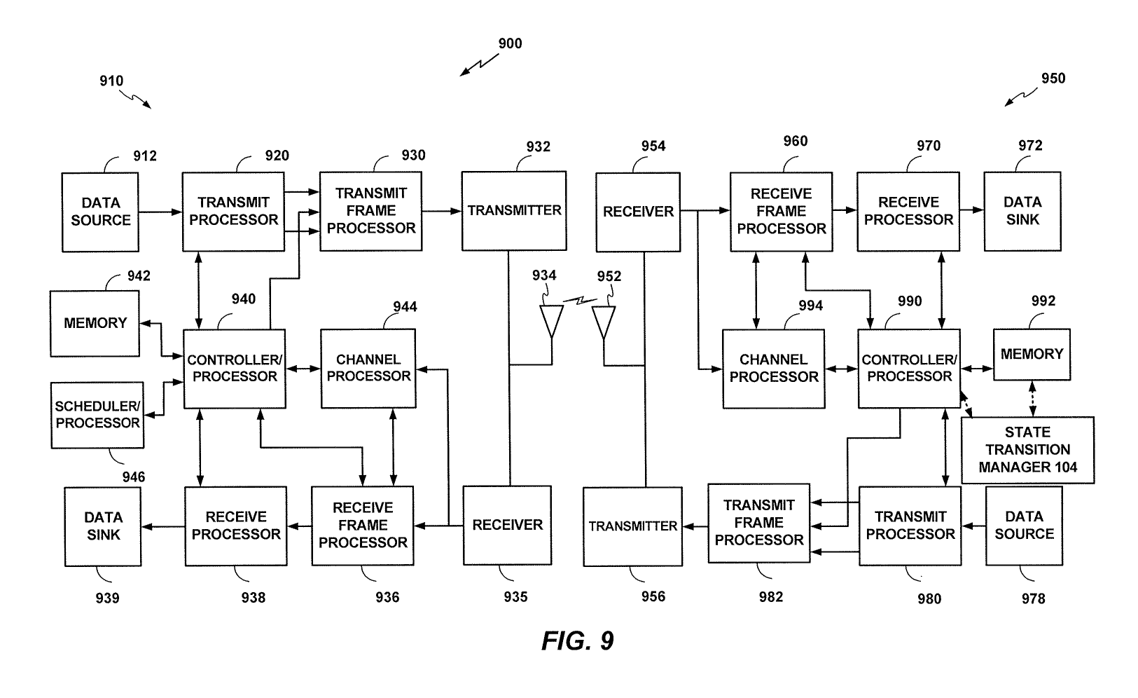

FIG. 9 is a block diagram of a Node B 910 in communication with a UE 950, where the Node B 910 may be base station 112 of network entity 110 and/or the UE 950 may be the same as or similar to UE 102 of FIG. 1 in that it is configured to include state transition manager 104 (FIG. 1) for managing state transitions at the UE, in controller/processor 990 and/or memory 992. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and de-spreads the symbols, and then determines the most likely signal constellation points transmitted by the Node B 910 based on the modulation scheme. These soft decisions may be based on channel estimates computed by the channel processor 994. The soft decisions are then decoded and de-interleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receive processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for managing radio resource control (RRC) state transitions at a user equipment (UE), comprising:
transmitting a reconfiguration complete message to a network entity, wherein the reconfiguration complete message is transmitted to the network entity in response to receiving a reconfiguration message from the network entity;
starting a reselection delay timer simultaneously with the transmitting of the reconfiguration complete message;
identifying initiation of a cell reselection procedure at the UE;
delaying the cell reselection procedure at the UE until the UE receives a layer 2 acknowledgement (L2 ACK) message from the network entity;
stopping the reselection delay timer in response to receiving the L2 ACK message; and
transitioning the UE to a cell_paging channel (cell_PCH) state from a cell_forward access channel (cell_FACH) state after the stopping of the reselection delay timer.

2. The method of claim 1, further comprising:
continuing with the cell reselection procedure after the transitioning of the UE to the cell_PCH state.

3. The method of claim 1, wherein the reconfiguration message is a physical channel reconfiguration message and the reconfiguration complete message is a physical channel reconfiguration complete message

4. The method of claim 1, wherein the reconfiguration message is received at the UE in response to a signaling connection release indicator (SCRI) message sent from the UE to the network entity, and wherein the SCRI message is associated with fast dormancy feature.

5. The method of claim 1, wherein the cell reselection procedure is triggered due to mobility of the UE.

6. The method of claim 1, wherein the UE waits for the L2 ACK message from the network entity prior to transitioning to the cell_PCH state from the cell_FACH state.

7. An apparatus for managing radio resource control (RRC) state transitions at a user equipment (UE), comprising:
means for transmitting a reconfiguration complete message to a network entity, wherein the reconfiguration complete message is transmitted to the network entity in response to receiving a reconfiguration message from the network entity;
means for starting a reselection delay timer simultaneously with the transmitting of the reconfiguration complete message;
means for identifying initiation of a cell reselection procedure at the UE;
means for delaying the cell reselection procedure at the UE until the UE receives a layer 2 acknowledgement (L2 ACK) message from the network entity;
means for stopping the reselection delay timer in response to receiving the L2 ACK message; and
means for transitioning the UE to a cell_paging channel (cell_PCH) state from a cell_forward access channel (cell_FACH) state after the stopping of the reselection delay timer.

8. The apparatus of claim 7, further comprising:
means for continuing with the cell reselection procedure after the transitioning of the UE to the cell_PCH state.

9. The method of claim 7, wherein the reconfiguration message is a physical channel reconfiguration message and the reconfiguration complete message is a physical channel reconfiguration complete message

10. The apparatus of claim 7, wherein the reconfiguration message is received at the UE in response to a signaling connection release indicator (SCRI) message sent from the UE to the network entity, and wherein the SCRI message is associated with fast dormancy feature.

11. The apparatus of claim 7, wherein the cell reselection procedure is triggered due to mobility of the UE.

12. The apparatus of claim 7, wherein the UE waits for the L2 ACK message from the network entity prior to transitioning to the cell_PCH state from the cell_FACH state.

13. A non-transitory computer readable medium storing computer executable code for managing radio resource control (RRC) state transitions at a user equipment (UE), comprising:
code for transmitting a reconfiguration complete message to a network entity, wherein the reconfiguration complete message is transmitted to the network entity in response to receiving a reconfiguration message from the network entity;
code for starting a reselection delay timer simultaneously with the transmitting of the reconfiguration complete message;
code for identifying initiation of a cell reselection procedure at the UE;
code for delaying the cell reselection procedure at the UE until the UE receives a layer 2 acknowledgement (L2 ACK) message from the network entity;
code for stopping the reselection delay timer in response to receiving the L2 ACK message; and
code for transitioning the UE to a cell_paging channel (cell_PCH) state from a cell_forward access channel (cell_FACH) state after the stopping of the reselection delay timer.

14. The computer readable medium of claim 13, further comprising:
code for continuing with the cell reselection procedure after the transitioning of the UE to the cell_PCH state.

15. The method of claim 13, wherein the reconfiguration message is a physical channel reconfiguration message and the reconfiguration complete message is a physical channel reconfiguration complete message

16. The computer readable medium of claim 13, wherein the reconfiguration message is received at the UE in response to a signaling connection release indicator (SCRI) message sent from the UE to the network entity, and wherein the SCRI message is associated with fast dormancy feature.

17. The computer readable medium of claim 13, wherein the cell reselection procedure is triggered due to mobility of the UE.

18. The computer readable medium of claim 13, wherein the UE waits for the L2 ACK message from the network entity prior to transitioning to the cell_PCH state from the cell_FACH state.

19. An apparatus for managing radio resource control (RRC) state transitions at a user equipment (UE), comprising:
a reconfiguration message component to transmit a reconfiguration complete message to a network entity, wherein the reconfiguration complete message is transmitted to the network entity in response to receiving a reconfiguration message from the network entity;
a timer starting component to start a reselection delay timer simultaneously with the transmitting of the reconfiguration complete message;
a reselection component to identify initiation of a cell reselection procedure at the UE;
the reselection component to delay the cell reselection procedure at the UE until the UE receives a layer 2 acknowledgement (L2 ACK) message from the network entity;
a time stopping component to stop the reselection delay timer in response to receiving the L2 ACK message; and
a state transition component to transition the UE to a cell_paging channel (cell_PCH) state from a cell_forward access channel (cell_FACH) state after the stopping of the reselection delay timer.

20. The apparatus of claim 19, wherein the reselection component is further configured to continue with the cell reselection procedure after the transitioning of the UE to the cell_PCH state.

21. The method of claim 19, wherein the reconfiguration message is a physical channel reconfiguration message and the reconfiguration complete message is a physical channel reconfiguration complete message

22. The apparatus of claim 19, wherein the reconfiguration message is received at the UE in response to a signaling connection release indicator (SCRI) message sent from the UE to the network entity, and wherein the SCRI message is associated with fast dormancy feature.

23. The apparatus of claim 19, wherein the cell reselection procedure is triggered due to mobility of the UE.

24. The apparatus of claim 19, wherein the UE waits for the L2 ACK message from the network entity prior to transitioning to the cell_PCH state from the cell_FACH state.
